(19) United States
(12) Patent Application Publication
(10) Pub. No.: US 2022/0391806 A1
(43) Pub. Date: Dec. 8, 2022

(54) METHOD TO COMPUTE A VISIBILITY INDEX FOR SHARED VEHICLES

(71) Applicant: HERE Global B.V., Eindhoven (NL)

(72) Inventor: Jerome Beaurepaire, Berlin (DE)

(21) Appl. No.: 17/342,030

(22) Filed: Jun. 8, 2021

(51) Int. Cl. G06Q 10/06; G06Q 50/30; G06Q 30/02; G06F 16/29; G06T 17/05

(52) U.S. Cl. CPC G06Q 10/06315; G06Q 50/30; G06Q 30/0284; G06F 16/29; G06T 17/05; G06Q 2240/00

(57) ABSTRACT

System and methods are provided for computing visibility values for locations for parking shared vehicles (e.g., light micro-mobility vehicles, electric vehicles, micro-mobility vehicles, etc.), based on the location's surrounding and map related information. A visibility value for a location of a shared vehicle is computed based on multiple criteria such as visibility from the street using street level imagery and sight lines among other data. The visibility values may be used by a shared vehicle service to request that users not park or store a shared vehicle in areas where the visibility index is below a threshold.

### FIELD

The following disclosure relates to navigation devices or services.

### BACKGROUND

Electric scooters, docked and dockless shared bikes, and other shared vehicle types are shrinking the physical footprint needed to move people over relatively short distances. Collectively dubbed shared transport or shared mobility, these services have the potential to better connect people with public transit, reduce reliance on private cars, and make the most of existing space by “right-sizing” the vehicle, all while reducing greenhouse gas emissions.

Yet like any new entrants into a well-established system, many of these services have faced resistance, backlash, and growing pains, as can be seen most visibly in the rocky relationship between governments and the service providers. Shared mobility providers may desire to have their vehicles placed in highly trafficked and visible locations while governments and businesses may wish to limit the disruption caused by the use of public spaces. Accordingly, due to regulations or city layouts, one problem for micro-mobility and shared vehicle operators in general is that the shared vehicles may not be able to be parked or stored in easily accessible and visible locations. As an example, certain parking locations may be located far away from a street or sidewalk and as such the vehicle may not be visible to potential users and not easy to find for users that select the shared vehicle on a mobile application. Other parking locations may be obscured by walls, foliage, or otherwise not be in a line of sight of the pedestrian flow.

A shared vehicle parked in a less visible area may be used less and thus less useful in accomplishing the goals of micro-mobility. There is a need to identify the visibility of certain areas for storing shared vehicles in order for operators and providers to efficiently operate fleets of shared vehicles and provide good service to potential users.

### SUMMARY

In an embodiment, a method is provided for computing a visibility value for a shared vehicle, the method comprising: identifying a possible storage location for the shared vehicle; calculating a plurality of pedestrian paths for areas within line of sight of the possible storage location; determining line of sight data for the possible storage location and the plurality of pedestrian paths based on three-dimensional mapping data; computing a visibility value for the possible storage location as a function of the plurality of pedestrian paths and line of sight data; and storing the visibility value for the possible storage location in a visibility index.

In an embodiment, a method for storing a shared vehicle, the method comprising: determining, by a shared mobility application, that an operation of a shared vehicle by a user is finished; identifying, by the shared mobility application, a first location for storage or parking of the shared vehicle; determining, by the shared mobility application, that the first location is insufficiently visible based on a visibility value for the first location; and recommending, by the shared mobility application, a second location for storage or parking of the shared vehicle, wherein the second location includes a visibility value higher than the visibility value for the first location.

In an embodiment, a system for computing a visibility value for a shared vehicle, the system comprising a geographic database and a processor. The geographic database is configured to store mapping data for at least a plurality of possible storage locations for the shared vehicle. The processor is configured to determine line of sight data for the plurality of possible storage locations from a plurality of observer points based on the mapping data and compute a visibility value for each of the plurality of possible storage locations as a function of the line-of-sight data, wherein the visibility values are stored in a visibility index that is part of the geographic database.

### BRIEF DESCRIPTION OF THE DRAWINGS

Exemplary embodiments of the present invention are described herein with reference to the following drawings.

FIG. 1 depicts an example system for computing visibility values for locations to store or park shared vehicles according to an embodiment.

FIG. 2 depicts an example region of a geographic database.

FIG. 3 depicts an example geographic database of FIG. 2.

FIG. 4 depicts an example structure of the geographic database.

FIG. 5 depicts an example workflow for computing a visibility value according to an embodiment.

FIG. 6 depicts an example region with possible parking locations and prohibited parking locations.

FIG. 7 depicts example pedestrian paths in the example region of FIG. 6.

FIG. 8 depicts example observer points on the pedestrian paths of FIG. 7.

FIG. 9 depicts example sight lines for the observer points of FIG. 8.

FIG. 10 depicts example sight lines for the observer points of FIG. 8.

FIG. 11 depicts an example visibility index map according to an embodiment.

FIG. 12 depicts an example device of FIG. 2.

FIG. 13 depicts an example workflow for applying a visibility value using the device of FIG. 12.

FIG. 14 depicts an example autonomous vehicle according to an embodiment.

### DETAILED DESCRIPTION

Embodiments provide a system and method of computing visibility values for locations for parking shared vehicles based on map related information for the respective locations. The visibility value provides better access to mobility, an ability to increase visibility for the shared vehicles, less frustration for users, higher return on investment for mobility operators, and lower operational costs.

With the emergence of shared vehicle services (e.g., shared cars, bicycles, motorcycles, boats, mopeds, scooters, etc.), the importance of finding both accessible and visible positions for the parked shared vehicle have also increased. As used herein, a shared vehicle may be a car, a motorcycle, an electric bike, an electric scooter, a bicycle, a kickboard, a mini scooter, a boat, etc. owned by an individual, a commercial business, a public agency, a cooperative, or an ad hoc grouping. The shared vehicle may be human-operated, semi-autonomous, or autonomous. Sharing refers to the shared use of the vehicle between different operators. By way of example, shared vehicle services generally offer a fleet of vehicles that can be “booked” or reserved for use by users. After the user has completed their trip, the shared vehicle is checked out or returned by the user, such that a next user can use the vehicle. Certain shared vehicles may be docked, e.g., parked at specific locations using docking equipment. Other dockless shared vehicles, however, include the ability for trips to end almost anyway and thus include essentially unlimited potential parking or storage locations. Docked and dockless shared vehicles typically use location-based services in order to track both the use and parking locations of the shared vehicles. Location-based solutions may provide valuable service to consumers by minimizing the time a user spends attempting to check out or return a shared vehicle. A user may be able to pinpoint the exact location of a parked vehicle using an application based on the previously identified location that is provided when the shared vehicle has ended its previous trip. If, however, a user is attempting to find a shared vehicle without an application or if the shared vehicle is parked in a non-visible location, the initial contact or transaction may not be easy or efficient and the user may forgo use of the shared vehicle. Additionally, in some circumstances (such as urban environments) location-based services may be less reliable and thus may misrepresent a location of the shared vehicle. This causes the shared vehicle service to potentially lose money and reduce the number of customers served or the utilization rates of the shared vehicles.

Embodiments provide a system and method of computing a visibility index for locations for parking shared vehicles (e.g., light micro-mobility vehicles, electric vehicles, micro-mobility vehicles, etc.), based on the location's surrounding and map related information. Embodiments allow consumers to find parked shared vehicles more quickly and efficiently. A visibility value for a location of a shared vehicle is computed based on multiple criteria such as visibility from the street using street level imagery, line of sight computations, satellite images, building footprints, point of interests, pedestrian flow, traffic flow, three-dimensional maps and building geometries, other visual obstacles, seasonal obstacles or natural elements, parking areas (indoor and outdoor), and/or probe data of pedestrians. A visibility index map may be created with all the computed values for different locations. The visibility values/map may be used by a shared vehicle service to request that users not park or store a shared vehicle in areas where the visibility index is below a threshold. The visibility values may be varied over time based on dynamic factors (such as weather, traffic and pedestrian flow over the normal course of the day, presence of elements hiding the location such as a parked truck, etc.). The shared vehicle's sensors data may also be used for determining its visibility index by reporting nearby elements that are likely to affect its visibility.

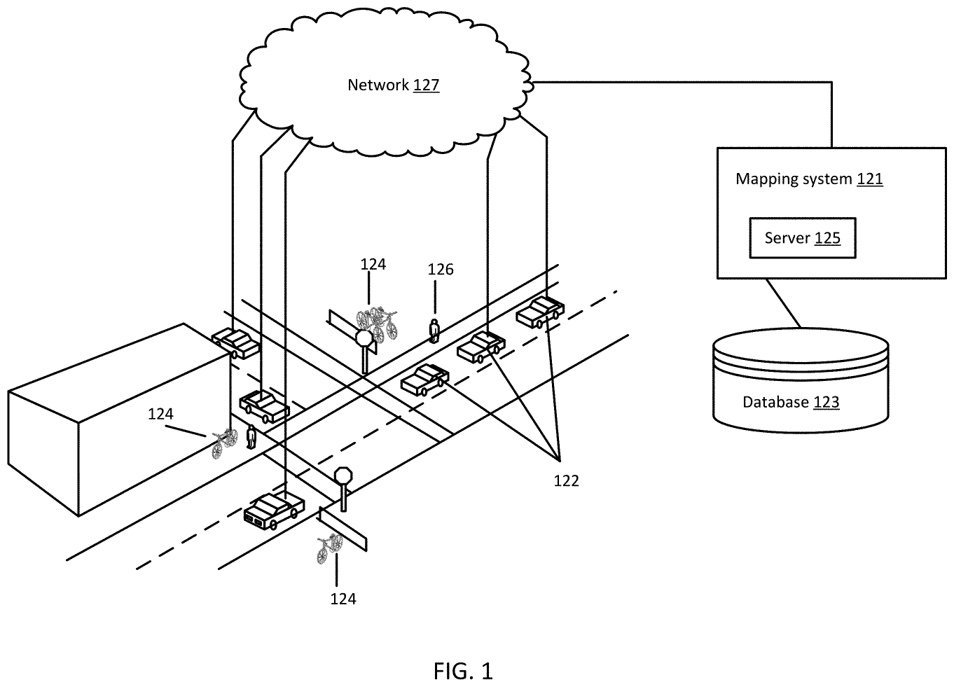

FIG. 1 illustrates an example system for computing visibility values for locations to store or park shared vehicles. The system includes at least a shared vehicle 124, one or more devices 122, a network 127, and a mapping system 121. The mapping system 121 may include a database 123 (also referred to as a geographic database 123 or map database) and a server 125. A user 126 is also depicted. The user 126 may be carrying a device 122 that is configured to rent or engage with one or more of the shared vehicles 124. Additional, different, or fewer components may be included. In an embodiment, a user rents a shared vehicle 124 using a device 122, travels on or in the shared vehicle 124 and arrives at the user's intended location. The user then releases (checks-out or returns) the shared vehicle 124 at the conclusion of their trip. The user may use an application for initiating the release of the shared vehicle 124 or engage a mechanism that indicates that the trip is over. A positioning module or location module equipped on the shared vehicle 124 may attempt to report to the mapping system 121 a position of the parked shared vehicle 124. This may also be performed by the application on the device 122. The position may be cross checked with a mapping system 121 to determine if the position exceeds a visibility threshold. If not, the application or shared vehicle 124 may request the user move the shared vehicle 124 to a different more visible location. The user may be charged more for parking the shared vehicle 124 in a low visibility location. Similarly, a user may be charged less to rent a shared vehicle 124 that is in a low visibility location.

The shared vehicle 124 may be a car, a motorcycle, an electric bike, an electric scooter, a bicycle, a kickboard, a mini scooter, a boat, etc. owned by an individual, a commercial business, a public agency, a cooperative, or an ad hoc grouping. The shared vehicle 124 may be human-operated, semi-autonomous, or autonomous. Shared use of a vehicle may be referred to as shared mobility. Shared mobility may include transportation services and resources that are shared among users, either concurrently or one after another. Services such as vehicle sharing, bike sharing, scooter sharing, on demand ride services, and ride sharing may all be included in the category of shared mobility.

Carsharing provides a network of cars available to users for short-term use, with borrowing time generally measured in hours rather than days like traditional car rental. Carsharing is generally used for mid-to-long range trips (5 to 20+ miles), for example when shopping or other cargo is involved and a vehicle is required. A single hourly price generally includes the costs of fuel and insurance, and often parking and tolls. Pricing may reflect variable demand for vehicles over the course of the week. Rentals may be self-service, relying on apps and transponders that allow remote access to vehicles, and employ either a dedicated fleet owned and managed by the service provider or vehicles sourced from other community members (e.g., peer-to-peer carsharing). While there may be certain designated parking spots for shared cars, many times (for example with peer-to-peer carsharing) the shared vehicles 124 are dispersed at random among other parked vehicles on the roadway. Shared cars may be parked in off-street parking such as garages or parking lots and thus may include varying degrees of visibility.

Bikesharing provides shared bikes available for self-service rentals of between a few minutes to up to a day for example. Bikesharing typically includes two service configurations, docked and dockless. Hybrid configurations using both docks and free-floating bikes may also be used. Docked bikeshare is a station-based system in which users unlock bikes from a fixed dock and return them to another dock at the end of a trip. Dockless bikeshare uses location-enabled “smart bikes” with integrated locks that may be unlocked via a mobile application. Users end a ride by locking the bike anywhere within the defined operating area. Because the parking locations are essentially limitless, the visibility of dockless bikesharing has widely varying degrees of visibility. Bikes may be parked or stored in highly visible areas such as right next to a sidewalk or roadway. Bikes, however, may also be located in highly imperceptible locations such as behind trees, bushes, fences, etc.

Scootersharing, for example, electric scooters available for short-term rental, is similar to dockless bikeshare, using the same technologies to enable service but relying on motorized scooters. Scootersharing includes the same visibility issues as dockless bike sharing as parked scooters may essentially be parked anywhere. Other types of shared vehicles 124 may be used. Shared boats, carts, planes, etc. may all have visibility issues for locating and making use of the shared vehicle 124.

Shared mobility services provide cost savings, provide convenience, and reduce vehicle usage, vehicle ownership, and vehicle mile travelled. Different types of shared mobility may be provided. For example, based on booking time frame, shared mobility services typically include on-demand (the customers can reserve vehicles in real time), reservation-based (reserved in advance), and mixed systems. In each of these scenarios, the user must find or locate the vehicle in order to use the shared vehicle 124. In one example, a user uses an application, for example on a device 122, to reserve a shared vehicle 124. The shared mobility application identifies the location of the user and the location of potential shared vehicles 124 in the vicinity of the search area. The user selects one of the shared vehicles 124 which is then reserved for that user for a period of time. At this point, the user must find the shared vehicle 124. In another example, a user may not reserve the shared vehicle 124 through the application, but rather come across an unreserved shared vehicle 124. In both these scenarios, if/when the user finds the shared vehicle 124, the user then unlocks the shared vehicle 124, begins their trip on or in the shared vehicle 124, and arrives at the user's intended location. The user then releases (check-out or return) the shared vehicle 124 at the conclusion of their trip.

The shared vehicle 124 may be equipped with one or more sensors that provide information about the environment around the shared vehicle 124 such as light sensors, LIDAR, radar, cameras, etc. The shared vehicle 124 may be configured to output visual or audio queues when the shared vehicle 124 is parked or stored in a low-visibility location. In an example, the shared vehicle 124 may be configured to make itself more visible by moving, re-orienting itself, or, for example, projecting a light towards a reflective surface.

The shared vehicle 124 may acquire data from the mapping system 121, server 125, or other devices 122. The one or more devices 122 may include devices carried by or used by potential users of the shared vehicle 124. The one or more devices 122 are configured to collect data about potential parking location and provide the data to the mapping system 121. The one or more devices 122 may also be configured to provide data about a location, a shared vehicle 124, or a mobility application to a user. The one or more devices 122 may include probe devices, probe sensors, or other devices 122 such as personal navigation devices 122 or connected vehicles. The mapping system 121 may communicate with the devices 122 through the network 127. The mapping system 121 may also receive data from one or more systems or services that may be used to identify the location of a vehicle or details about locations. The device 122 may be a navigation system built into the vehicle and configured to monitor the vehicle. The devices 122 may also be integrated in or with a vehicle. The devices 122 may include mobile phones running specialized applications that collect location data as the devices 122 are carried by persons or things traveling the roadway system. The devices 122 may be configured to collect and transmit data including a location of a shared vehicle 124 or information about locations. The devices 122 may be configured to provide guidance for a user or shared vehicle 124.

The mapping system 121 is configured to calculate visibility values for different locations based on information received from shared vehicles 124, devices 122, and other sources. The visibility value for a location may be calculated as a function of the pedestrian paths, pedestrian flow, and line of sight data, among other data. The visibility values may be computed to reflect the difficulty to find a shared vehicle 124 at a location, for example, from 0 to 1. On one end of the spectrum, the value 1 means that the shared vehicle 124 is effortlessly visible from the street when people are passing by, while the value 0 means that the shared vehicle 124 is completely hidden. The value may gradually increase based on the distance of this asset to the street, its visibility, its accessibility, the need to go around obstacles, etc. The values may vary based on dynamic factors (weather, presence of elements hiding it like a truck, etc). The values may be calculated differently for different types of shared vehicles 124.

The one or more devices 122 and/or the shared vehicle 124 may be configured to acquire the information on which the visibility values are based. The one or more devices 122 may include one or more sensors configured to acquire data about the roadway or locations located in and about the roadway. These sensors may include positioning sensors, image or video sensors, ranging sensors etc. The shared vehicle 124 may include a variety of devices or sensors that collect data and information about the location and surroundings of the shared vehicle 124. Similar to the one or more devices 122, these devices/sensors may include positioning sensors, image or video sensors, ranging sensors etc.

The one or more devices 122 and/or the shared vehicle 124 may be configured to acquire positioning data to identify or monitor a location. Positioning data may be generated by a global positioning system, a dead reckoning-type system, cellular location system, or combinations of these or other systems, that may be referred to as position circuitry or a position detector. The positioning circuitry may include suitable sensing devices that measure the traveling distance, speed, direction, and so on, of a device 122 or shared vehicle 124. The positioning system may also include a receiver and correlation chip to obtain a GPS or GNSS signal. Alternatively, or additionally, the one or more detectors or sensors may include an accelerometer built or embedded into or within the interior of a vehicle that provides information to a device 122. A vehicle may include one or more distance data detection devices or sensors, such as a LiDAR or RADAR device. Radar sends out radio waves that detect objects and gauge their distance and speed in relation to the vehicle in real time. Both short- and long-range radar sensors may be deployed all around the car and each one has their different functions. While short range (24 GHz) radar applications enable blind spot monitoring, for example lane-keeping assistance, and parking aids, the roles of the long range (77 GHz) radar sensors include automatic distance control and brake assistance. Unlike camera sensors, radar systems typically have no trouble when identifying objects during fog or rain. The vehicle may also be equipped with LiDAR. LiDAR sensors work similar to radar systems, with the difference being that LiDAR uses lasers instead of radio waves. Apart from measuring the distances to various objects on the road, the vehicle may use LiDAR to create three-dimensional images of the detected objects and map the surroundings. The vehicle may use LiDAR to create a full 360-degree map around the vehicle rather than relying on a narrow field of view.

The distance data detection sensor may include a laser range finder that rotates a mirror directing a laser to the surroundings or vicinity of a collection vehicle on a roadway or another collection device on any type of pathway. Such a vehicle includes a communication device and an environment sensor array for detecting and reporting the surroundings of the vehicle to the mapping system 121 in order to, for example, generate a three-dimensional map or to identify and analyze lines of sight or obstructions that could limit visibility of a certain location. The vehicle may include an integrated communication device coupled with an in-dash navigation system. The vehicle may include an ad-hoc communication device such as a mobile device or smartphone in communication with a vehicle system. The communication device connects the vehicle to a network 127 including at least the mapping system 121.

The device 122 and/or shared vehicle 124 may also use passive sensors, such as vision-based techniques with cameras or other imaging sensors to understand its position and provide information to the mapping system 121 to analyze visibility of a particular location. Vision-based techniques are used to acquire information about visibility from the street using street level imagery (SLI), line of sight computations, building geometries, and other visual obstacles such as seasonal obstacles and natural elements. Video data, image data, or other sensor data may be collected and processed to identify information about a particular location. Image recognition methods or classifiers such as neural networks may be used to identify features or obstacles for an area. In an example, the device 122 may acquire image data/street level imagery about a location such as the presence or absence of a fence, hedge, wall, etc. The image data may be used by the mapping system 121 along with mapping data stored in the geographic database 123 to understand the presence or absence of sight lines from the location of the device 122 to the particular location. If, for example, an obstacle is between the location of the device 122 and the particular location and a potential (or actual) shared vehicle 124 cannot be seen, then a visibility value for the particular location may be determined to be low. The image data/street level imagery may also be used to verify or as ground truth data for determining visibility and line of sight computations that otherwise may be performed by generating a three-dimensional map from satellite images, building geometries, or overhead images. Image data or other passive sensor data may also be used by the mapping system 121 to understand lighting or seasonal changes such as differences in sight lines between times of the day or days of the year.

Information about location acquired from devices 122, shared vehicles 124, and/or other sources is stored in a geographic database 123. The geographic database 123 includes information about one or more geographic regions. The HD map and the geographic database 123 may be maintained by a content provider (e.g., a map developer). By way of example, the map developer may collect geographic data to generate and enhance the geographic database 123. The map developer may obtain data from sources, such as businesses, municipalities, or respective geographic authorities. In addition, the map developer may employ field personnel to travel throughout the geographic region to observe features and/or record information about the roadway. Remote sensing, such as aerial or satellite photography, may be used. The database 123 is connected to the server 125. The geographic database 123 and the data stored within the geographic database 123 may be licensed or delivered on-demand. Other navigational services or traffic server providers may access the traffic data stored in the geographic database 123. Data for an object or point of interest may be broadcast as a service.

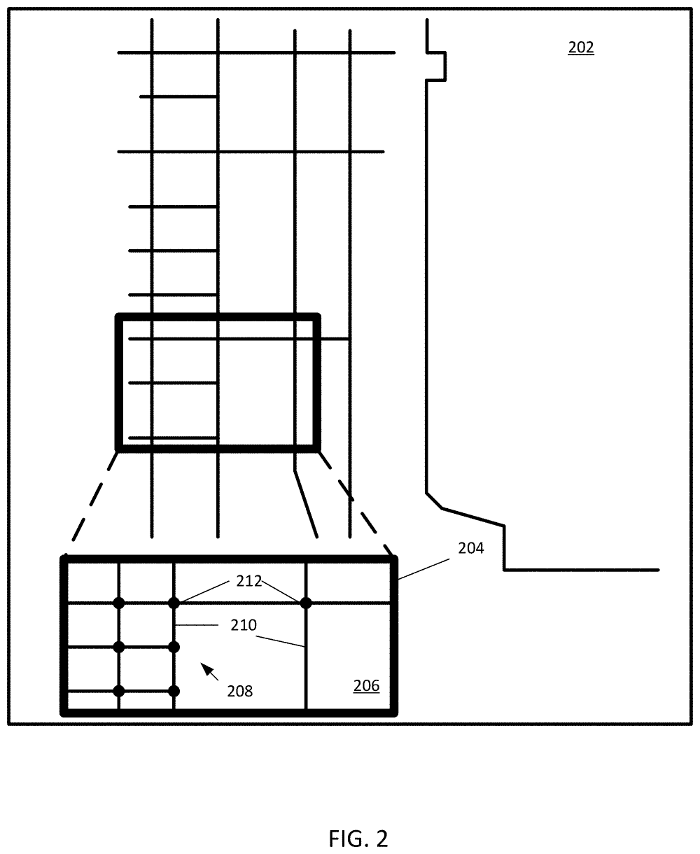

FIG. 2 illustrates a map of a geographic region 202. The geographic region 202 may correspond to a metropolitan or rural area, a state, a country, or combinations thereof, or any other area. Located in the geographic region 202 are physical geographic features, such as roads, points of interest (including businesses, municipal facilities, etc.), lakes, rivers, railroads, municipalities, etc.

FIG. 2 further depicts an enlarged map 204 of a portion 206 of the geographic region 202. The enlarged map 204 illustrates part of a road network 208 in the geographic region 202. The road network 208 includes, among other things, roads and intersections located in the geographic region 202. As shown in the portion 206, each road in the geographic region 202 is composed of one or more road segments 210. A road segment 210 represents a portion of the road. Road segments 210 may also be referred to as links. Each road segment 210 is shown to have associated with it one or more nodes 212; one node represents the point at one end of the road segment and the other node represents the point at the other end of the road segment. The node 212 at either end of a road segment 210 may correspond to a location at which the road meets another road, i.e., an intersection, or where the road dead ends.

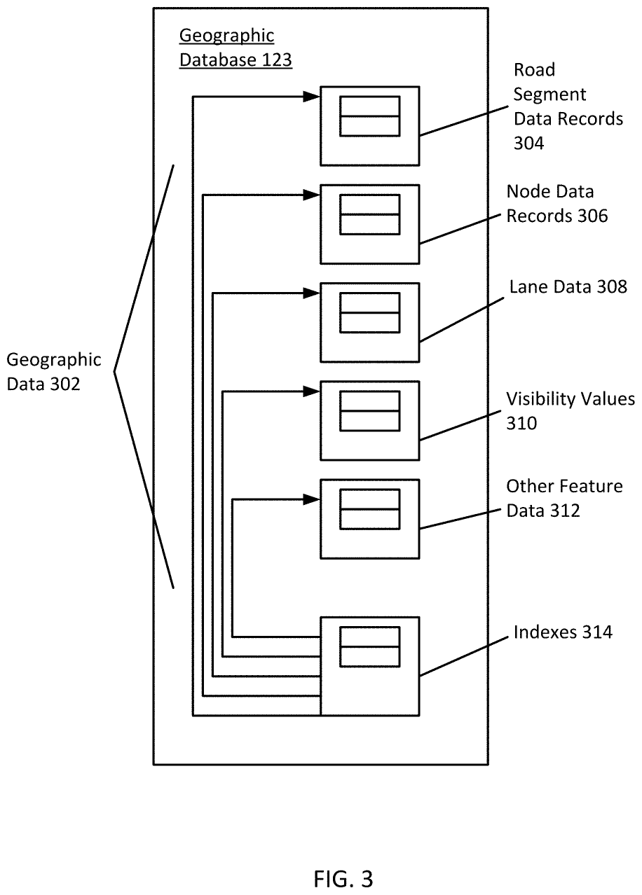

As depicted in FIG. 3, in one embodiment, the geographic database 123 contains geographic data 302 that represents some of the geographic features in the geographic region 202 depicted in FIG. 2. The data 302 contained in the geographic database 123 may include data that represent the road network 208 and/or regions in and around the roadway network 208. In FIG. 3, the geographic database 123 that represents the geographic region 202 may contain at least one road segment database record 304 (also referred to as “entity” or “entry”) for each road segment 210 in the geographic region 202. The geographic database 123 that represents the geographic region 202 may also include a node database record 306 (or “entity” or “entry”) for each node 212 in the geographic region 202. The terms “nodes” and “segments” represent only one terminology for describing these physical geographic features, and other terminology for describing these features is intended to be encompassed within the scope of these concepts.

The geographic database 123 may include feature data 308-312. The feature data 312 may represent types of geographic features. For example, the feature data may include roadway data 308 including signage data, lane data, traffic signal data, physical and painted features like dividers, lane divider markings, road edges, center of intersection, stop bars, overpasses, overhead bridges etc. The roadway data 308 may be further stored in sub-indices that account for different types of roads or features. The point of interest data may include data or sub-indices or layers for different types points of interest. The point of interest data may include point of interest records comprising a type (e.g., the type of point of interest, such as restaurant, fuel station, hotel, city hall, police station, historical marker, ATM, golf course, truck stop, vehicle chain-up stations etc.), location of the point of interest, a phone number, hours of operation, etc. The feature data 312 may include other roadway features. The geographic database 123 also includes indexes 314. The indexes 314 may include various types of indexes that relate the different types of data to each other or that relate to other aspects of the data contained in the geographic database 123. For example, the indexes 314 may relate the nodes in the node data records 306 with the end points of a road segment in the road segment data records 304.

In an embodiment, the visibility values 310 is stored in the geographic database 123. The visibility value index stores visibility values 310 for possible parking or storage locations for shared vehicles 124. There may be multiple visibility value index that are related to different types of shared vehicles 124. One visibility value index may relate to shared bicycles while another may relate to shared cars.

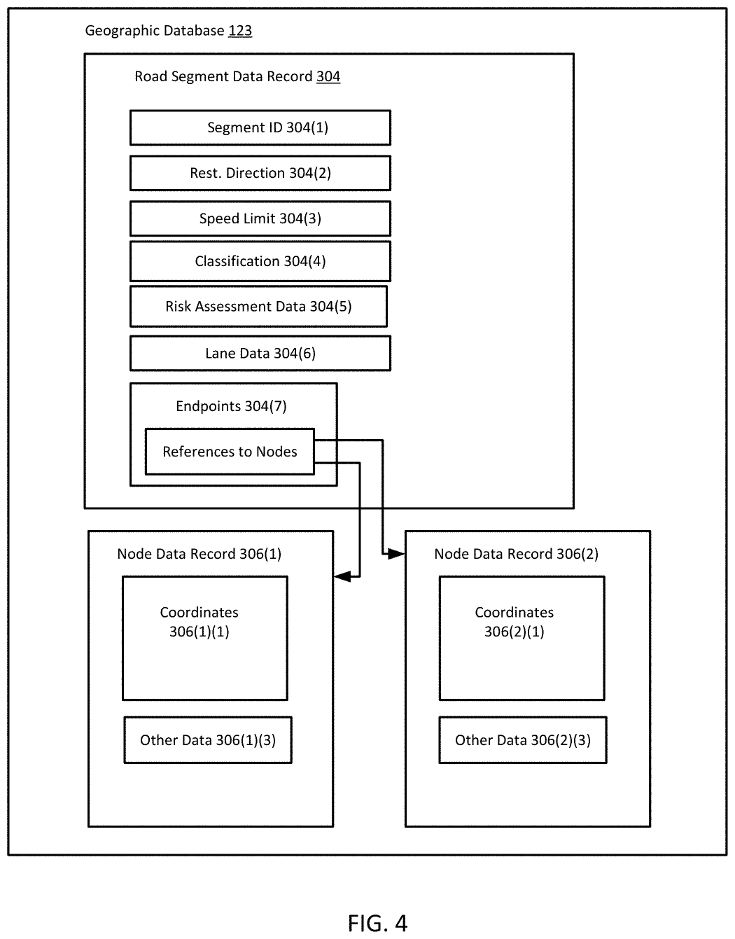

FIG. 4 shows some of the components of a road segment data record 304 contained in the geographic database 123 according to one embodiment. The road segment data record 304 may include a segment ID 304(1) by which the data record may be identified in the geographic database 123. Each road segment data record 304 may have associated with the data record, information such as “attributes”, “fields”, etc. that describes features of the represented road segment. The road segment data record 304 may include data 304(2) that indicate the restrictions, if any, on the direction of vehicular travel permitted on the represented road segment. The road segment data record 304 may include data 304(3) that indicate a speed limit or speed category (i.e., the maximum permitted vehicular speed of travel) on the represented road segment. The road segment data record 304 may also include data 304(4) indicating whether the represented road segment is part of a controlled access road (such as an expressway), a ramp to a controlled access road, a bridge, a tunnel, a toll road, a ferry, and so on. The road segment data record 304 may include data 304(5) related to points of interest. The road segment data record 304 may include data 304(6) that describes roadway data. The road segment data record 304 also includes data 304(7) providing the geographic coordinates (e.g., the latitude and longitude) of the end points of the represented road segment. In one embodiment, the data 304(7) are references to the node data records 306 that represent the nodes corresponding to the end points of the represented road segment. The road segment data record 304 may also include or be associated with other data 304(7) that refer to various other attributes of the represented road segment such as coordinate data for shape points, POIs, signage, other parts of the road segment, among others. The various attributes associated with a road segment may be included in a single road segment record or may be included in more than one type of record which cross-references to each other. For example, the road segment data record 304 may include data identifying what turn restrictions exist at each of the nodes which correspond to intersections at the ends of the road portion represented by the road segment, the name, or names by which the represented road segment is known, the street address ranges along the represented road segment, and so on.

FIG. 4 also shows some of the components of a node data record 306 which may be contained in the geographic database 123. Each of the node data records 306 may have associated information (such as “attributes”, “fields”, etc.) that allows identification of the road segment(s) that connect to it and/or a geographic position (e.g., latitude and longitude coordinates). For the embodiment shown in FIG. 4, the node data records 306(1) and 306(2) include the latitude and longitude coordinates 306(1)(1) and 306(2)(1) for their node. The node data records 306(1) and 306(2) may also include other data 306(1)(3) and 306(2)(3) that refer to various other attributes of the nodes. In an embodiment, the geographic database 123 stores the historical pedestrian data including the pedestrian probe data, the historical PDP, and historical PFP. The geographic database 123 may also include time stamps for different events that coincide with the pedestrian probe data. The event data (including for example, weather data) may also be used to set baseline values for PDP and PFP when the server 125 calculates surprise values. The pedestrian data may be stored as related to a segment, a node, a POI, an area, a quadkey, etc.

The data in in the geographic database 123 may also be organized using a graph that specifies relationships between entities. A Location Graph is a graph that includes relationships between location objects in a variety of ways. Objects and their relationships may be described using a set of labels. Objects may be referred to as “nodes” of the Location Graph, where the nodes and relationships among nodes may have data attributes. The organization of the Location Graph may be defined by a data scheme that defines the structure of the data. The organization of the nodes and relationships may be stored in an Ontology which defines a set of concepts where the focus is on the meaning and shared understanding. These descriptions permit mapping of concepts from one domain to another. The Ontology is modeled in a formal knowledge representation language which supports inferencing and is readily available from both open-source and proprietary tools.

The mapping system 121 and devices 122 are connected to the network 127. The shared vehicles 124 may also be connected to the mapping system 121 or devices 122 through the network 127. The devices 122, shared vehicles 124, and/or mapping system 121 may receive or transmit data through the network 127. The mapping system 121 may also transmit paths, routes, or feature data through the network 127. The network 127 may include wired networks, wireless networks, or combinations thereof. The wireless network may be a cellular telephone network, LTE (Long-Term Evolution), 4G LTE, a wireless local area network, such as an 802.11, 802.16, 802.20, WiMAX (Worldwide Interoperability for Microwave Access) network, DSRC (otherwise known as WAVE, ITS-G5, or 802.11p and future generations thereof), a 5G wireless network, or wireless short-range network. Further, the network 127 may be a public network, such as the Internet, a private network, such as an intranet, or combinations thereof, and may utilize a variety of networking protocols now available or later developed including, but not limited to transmission control protocol/internet protocol (TCP/IP) based networking protocols.

The mapping system 121 may include multiple servers 125, workstations, databases, and other machines connected together and maintained by a map developer. The mapping system 121 and/or server may include one or more processors configured to execute instructions such as detailed in the methods described below. A server 125 may be a host for a website or web service such as a mapping service and/or a navigation service. The mapping service may provide maps generated from the geographic data of the database 123, and the navigation service may generate routing or other directions from the geographic data of the database 123. The mapping service may also provide information generated from data included in the database 123. The server 125 may also provide historical, future, recent or current traffic conditions for the road segments, segments, paths, or routes using historical, recent, or real time collected data. The server 125 and/or mapping system 121 may provide or be used by a shared services application that provides access to shared vehicles 124.

The mapping system 121 is configured to calculate visibility values for different locations where a shared vehicle 124 may be parked or stored. The mapping system 121 is configured to store the visibility values in the geographic database 123 and/or otherwise make the visibility values accessible to user or applications that relate to shared vehicles 124. The mapping system 121 may be configured to update and adjust the visibility values over time as data is collected and processed. The mapping system 121 may be configured to identify and learn which locations lead to the lowest visibility index based on the type of location and, for example, mapping data stored in the geographic database 123. The mapping system 121 may inform users parking in such (more hidden) areas that that they should do their best to make the vehicle visible by turning on a light, orienting the shared vehicle 124 etc. The mapping system 121 may also forbid user to park in low visibility areas or incentivize users not to park there. The mapping system 121 may require users to take a picture before leaving the vehicle so the picture or image may be used to provide hints to a next user on the location of the shared vehicle 124.

In an example operation, the mapping system 121 acquires information about a plurality of locations. The mapping system 121 calculates, based on data stored in the geographic database 123, visibility values for each of the plurality of locations. The data stored in the geographic database 123 may include, for example, two-dimensional or three-dimensional maps of area around each location, pedestrian flow, satellite images, etc. The mapping system 121 stores the visibility values in the geographic database 123 for use by a share vehicle operator. The operator may, for example, require users to store or park shared vehicles 124 in a highly visible area either through incentives or disincentives. The operator may prohibit users from parking in certain areas. The mapping system 121 is configured to continuously collect data from devices 122 such as probe devices in the field and to update both the geographic database 123 and the visibility values. Real time information from users of shared vehicles 124 may also be used to adjust or update visibility values.

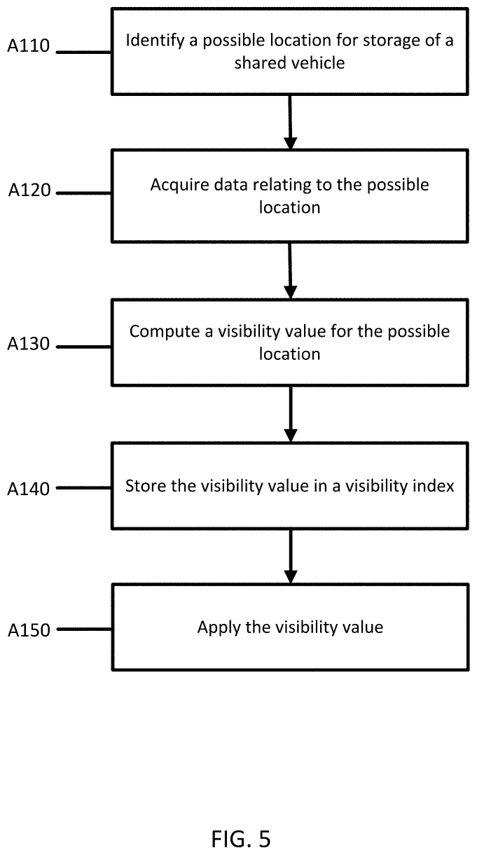

FIG. 5 illustrates an example flow chart for calculating a visibility value for a potential parking location of a shared vehicle 124. As presented in the following sections, the acts may be performed using any combination of the components indicated in FIG. 1, 12, or 14. The following acts may be performed by the server 125, the device 122, the mapping system 121, or a combination thereof. Additional, different, or fewer acts may be provided. The acts are performed in the order shown or other orders. The acts may also be repeated. Certain acts may be skipped.

At act A110, the mapping system 121 identifies a possible location for storage of a shared vehicle 124. Different locations or location types may apply to different types of shared vehicles 124. For example, a shared car may require a designated parked spot, while a shared bike or scooter may be parked on the roadway, on a sidewalk, or essentially anywhere that is legally allowed. Government regulations or privacy issues may prohibit or limit the use of certain locations. In an example, a shared vehicle 124 may be prohibited from being parked in spots that block pedestrian walkways, driveways or building entrances. Shared vehicles 124 may also should not be parked at crosswalks or bus stops. Shared vehicles 124 may be prohibited from blocking roadways and sidewalks. Shared vehicles 124 may also be prohibited from parking, for example, within ten feet of street corners or intersections, along building facades or block fire hydrants, bus stops/terminals, rail station entrances, loading zones, or building access points. Even though these locations may be highly visible, the locations are not permissible. As such, these locations may not be considered as a possible location.

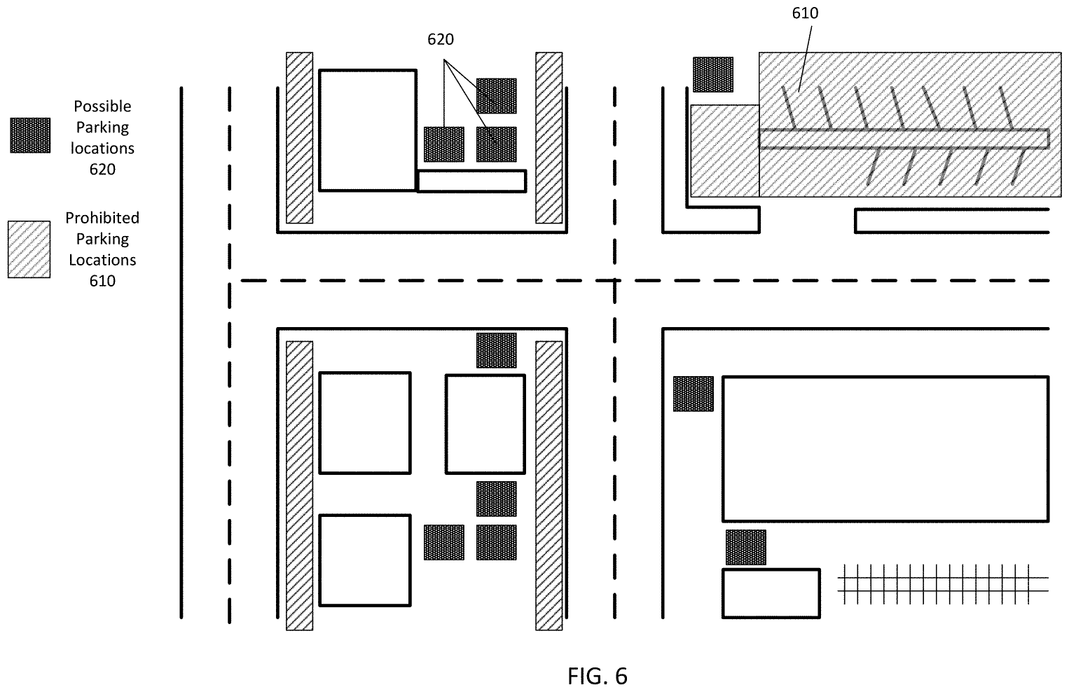

FIG. 6 depicts an example area and several possible locations for storage of a shared vehicle 124. Certain areas 610 may be off limits for parking a shared vehicle 124 such as a dockless bike. These off-limits or prohibited parking locations 610 are indicated in FIG. 6. In FIG. 6, there are four blocks depicted in the area with the block in the top right designated as a parking lot for cars and thus off-limits for parking certain shared vehicles 124. There are ten (10) possible parking locations 620 for the dockless bike. These possible parking locations 620 may be designated by regulation or may be commonly used locations. There may be many more possible parking locations 620 not depicted in the example area. For example, any location that is not prohibited may be used, for example locations on the sidewalk or right off the street in the bottom right. These ten possible parking locations 620 may, as such, be representative possible parking locations 620, but may not reflect the totality of the possible parking locations 620 in the example area. In an embodiment, the mapping system 121 uses a grid-based system to identify possible locations in advance of the actual storage of a shared vehicle 124. Each square or area may be, for example, 1 meter by 1 meter. Locations that are private property, limited by regulations, or otherwise unable to be used may be excluded. The following embodiments specifically relate to calculating a visibility value for a location. The accessibility of a location may be calculated separately or may be included as a component in the visibility value calculation. As an example, a location behind a fence may be visible to a potential customer, but not accessible.

The mapping system 121 may use data from the geographic database 123 to identify a possible parking location. The mapping system 121 may identify a plurality of locations in advance of the actual storage of a shared vehicle 124. Alternatively, the mapping system 121 may identify locations on demand, for example, as a trip or use of a shared vehicle 124 is ending and storing or parking the shared vehicle 124 is imminent. In an embodiment, the mapping system 121 identifies locations on demand. When a user ends a trip, the user selects a parking location which is transmitted to the mapping system 121 either using a device 122 of the user or by the shared vehicle 124. Both or either of the device 122 and shared vehicle 124 may use a positioning-based system such as GPS to identify the expected parking location.

At act A120, the mapping system 121 acquires data related to the possible location, for example line-of-sight data and/or street level imagery. The line-of-sight data may include, for example, visibility from the street using street level imagery (SLI), computations based on two-dimensional or three-dimensional map data, satellite images, building footprints, locations of POIs, pedestrian or traffic flow, building geometries, obstacles data such as seasonal obstacles/natural elements, designated parking areas (indoor and outdoor), lighting, etc. Mapping data may be acquired by devices 122 or other sensors in the area and stored in the geographic database 123. Derived data such as pedestrian flow, lighting, line of sight computations, etc. may be calculated by the mapping system 121 and stored in the geographic database 123.

Street level imagery may be captured by probe vehicles as the probe vehicles traverse the roadway. The street level imagery may be stitched together to form a continuous view from the street. The street level imagery may provide one or more sight lines for determining the visibility value. The street level imagery may be used to identify certain objects or features such as hedges, fences, trees, bushes, or other obstacles.

A three-dimensional map may be generated or otherwise accessed by the mapping system 121. The three-dimensional map provides information about obstacles and objects that may limit visibility of a potential location from the viewpoint of a potential customer. The three-dimensional map may be generated by using recorded measurements such as the size and footprint of a building or wall. The three-dimensional may also be generated by capturing data about a location using, for example, LIDAR or camera-based systems. three-dimensional maps may also be generated from overhead imagery or other data. In certain situations, a two-dimensional map may be used in place or along with the three-dimensional map. The two-dimensional map of FIG. 6, for example, may quickly provide information to a user but may lack certain feature data such as a height of a building, wall, hedge, etc. A crude three-dimensional map, however, may be generated by using a two-dimensional map and stored height measurements.

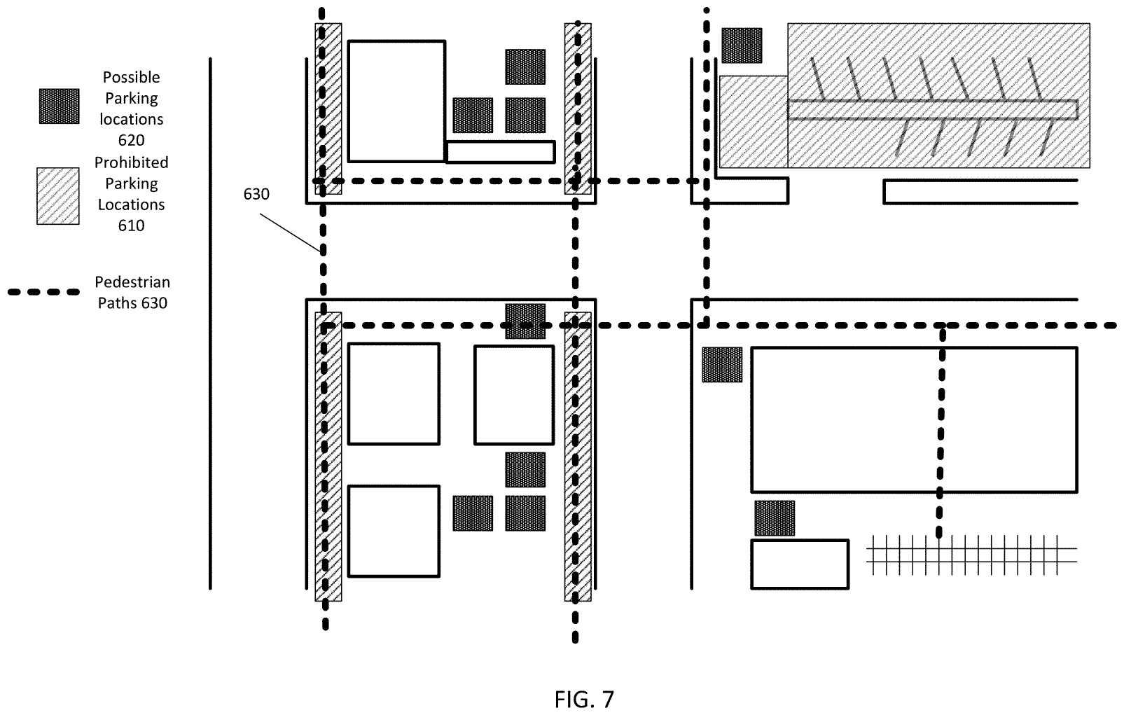

In an embodiment, the mapping system 121 may calculate pedestrian paths and pedestrian flow for an area around the possible location. Pedestrian paths/flow may be calculated or determined from probe reports or from observed behavior. FIG. 7 depicts pedestrian paths 630 for the area depicted in FIG. 6. As depicted, the pedestrian paths 630 follow the sidewalks of the area and cross the streets at designated crosswalks. While not depicted here, each path 630 may also include a volume value that relates to the volume or flow of traffic that takes each path during a specific time.

The mapping system 121 may determine line of sight data for the potential parking location based on two-dimensional or three-dimensional mapping data and the pedestrian paths 630. In an embodiment, the mapping system 121 selects a plurality of viewpoints (for example, at random or based on the pedestrian paths 630) and determines if the location is visible from each view point/observer point. The results may then be used to calculate the visibility value for the respective location.

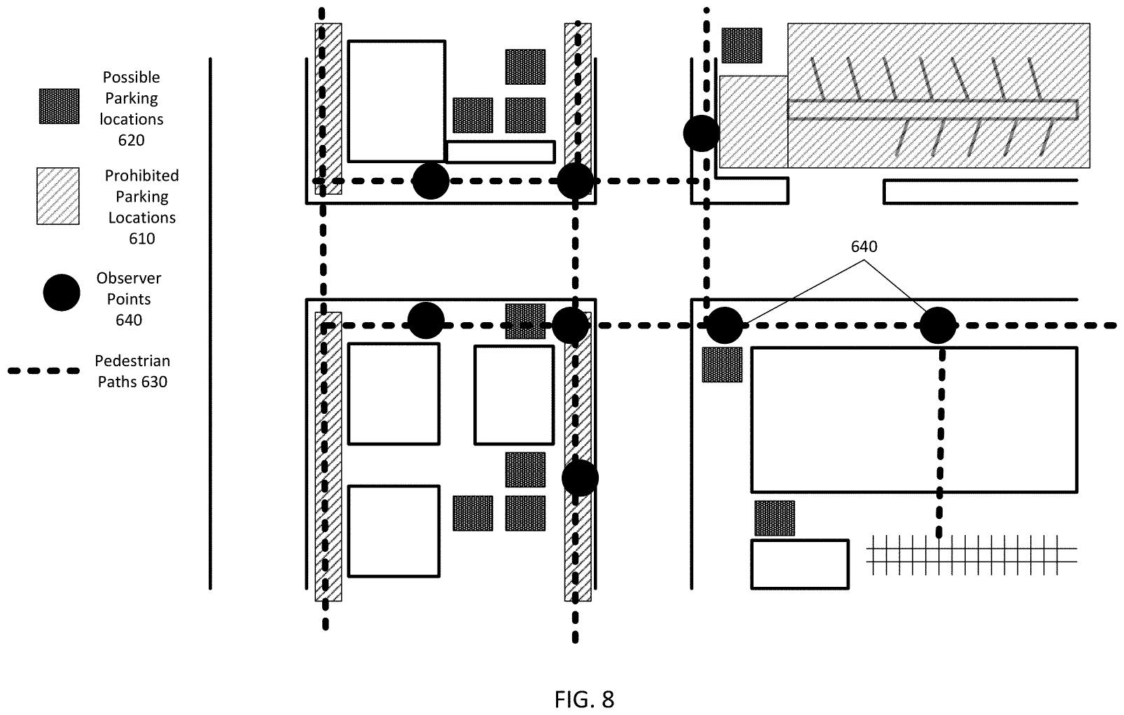

FIG. 8 depicts an example of several observer points 640/viewpoints selected from the pedestrian paths. In FIG. 8, there are 8 observer points 640. There may be many more or fewer observer points 640. For example, along each pedestrian path 630, a point may be selected every 0.1 meters, 0.2 meters, 0.5 meters, 1 meter, etc. Each observer point 640 may also be provided with a value that relates to the pedestrian traffic flow or volume at that point for a specific time. From each observer point 640, line of sight data is determined, for example if a person at a respective observer point 640 is able to see a shared vehicle 124 parked at the respective location. The ability to see the respective location may be determined as a binary calculation, e.g., 1 for yes, 0 for no, or may be based on a sliding scale where 1 is highly visible and 0 is not at all visible. In an embodiment, ray tracing may be used to determine line of sight data for a particular point. Multiple rays may be drawn from the potential location to determine if/when the rays intersect with the pedestrian paths. While FIG. 8 is depicted as two-dimensional, a three-dimensional map may be required due to elevation changes in the terrain. Lighting and shadows may also be taken into account when calculating line of sight data. Distance may also be a factor. Even with an unobstructed view of a location, a potential user may not be able to identify or see a shared vehicle 124 at the location if the location is too far away, there is bad lighting, or if the shared vehicle 124 is otherwise camouflaged by shadows or other objects.

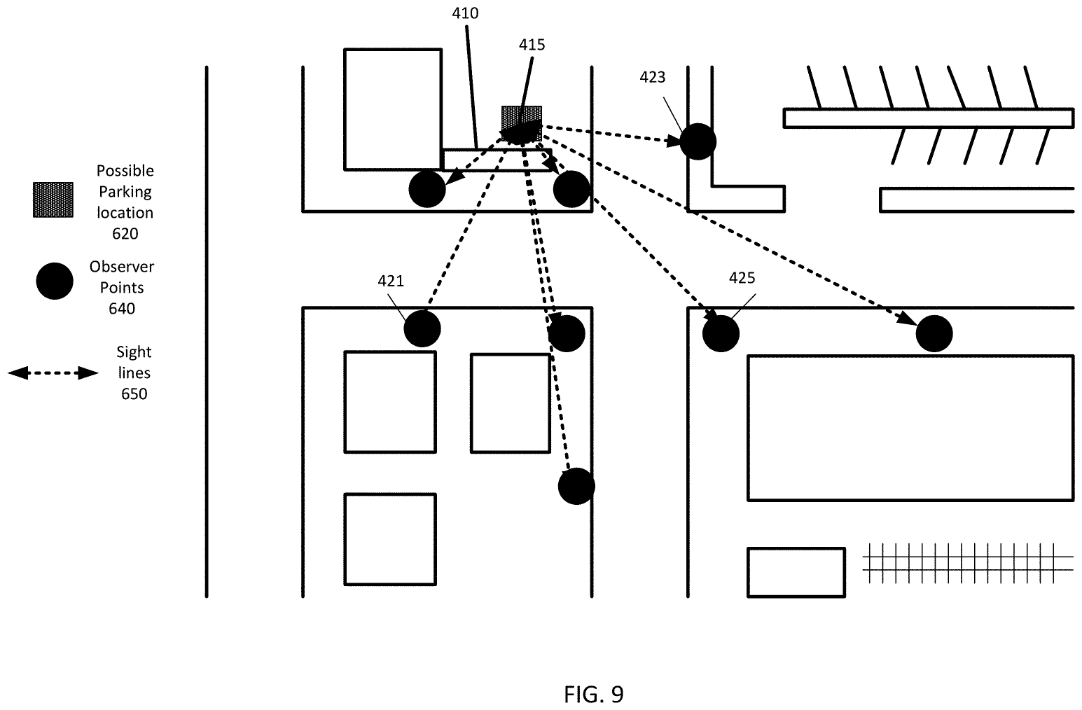

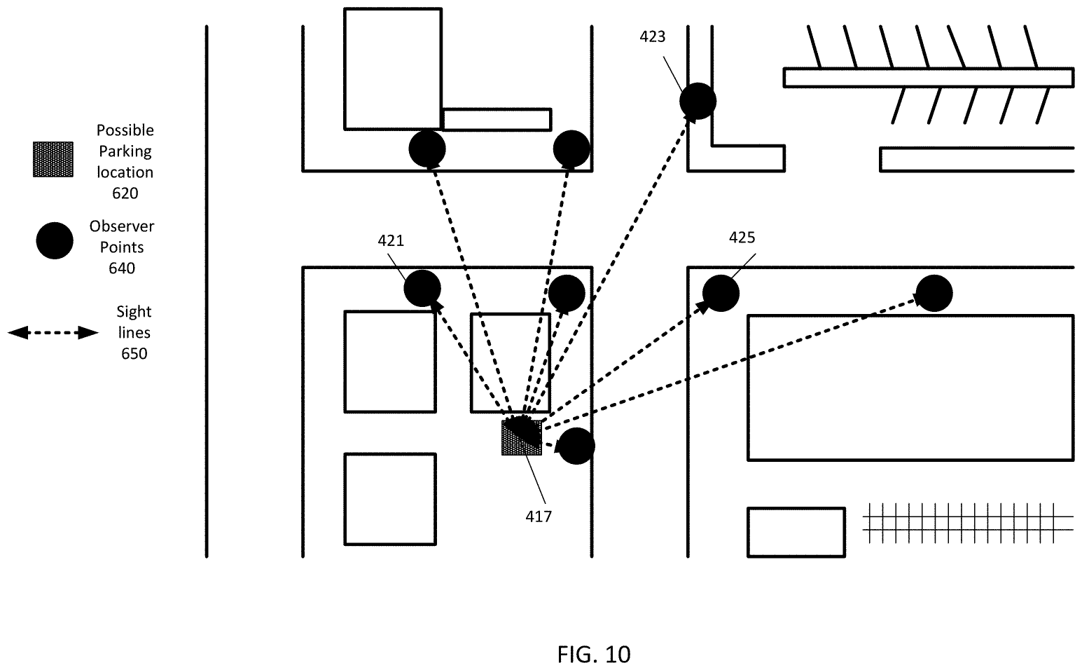

FIG. 9 depicts an example of multiple sight lines 650 from different observer points 423, 421, 425, 640 to a potential parking location 415, 620. As depicted, there may be a clear line of sight from observer point 423 to the potential parking location 415, a slightly obstructed line of sight from observer point 425, and a full obstructed line of sight from observer point 421 depending on a height of a structure 410. FIG. 10 depicts a second example of multiple sight lines 650 from different observer points 423, 421, 425, 640 to a potential parking location 417, 620. As depicted, there are partially or fully obstructed lines of sight from 421, 423, and 425.

At act A130, the mapping system 121 computes a visibility value for the possible location as a function of the information collected about the possible location. The visibility value may be computed to reflect the difficulty to find the shared vehicle 124 by an average or typical customer. The computation may take into account the pedestrian flow data that describes where and when pedestrians walk and whether or not a potential customer would be able to see or find a shared vehicle 124 at the specified location from the typical path described by the pedestrian flow. The computation may take into account the proximity to well trafficked areas. Certain locations may be more or less visible depending on the traffic flow and points of interest. In an example, a first location that is far away from a street may be more visible than a location that is closer to the street if the first location is highly visible from an exist, from for example, a commuter train station. The computation may take into account moveable or temporary obstacles such as a potential for a parked vehicle or object to block the view of a potential customer of the location. The computation may take into account dynamic factors such as lighting, weather, or seasonal changes.

In an embodiment, the visibility value ranges from 0 to 1. On one end of the spectrum, the value 1 means that the vehicle is effortlessly visible when people are passing by. The value 0 means that the vehicle is completely hidden. The value may gradually decrease or increase based on the distance of the shared vehicle 124 to the street or sidewalk. As an example, a shared vehicle 124 located 2 meters from the sidewalk may be much more visible than a shared vehicle 124 that is 20 meters from the sidewalk even if both locations have sight lines that are not blocked.

The visibility value may be an average visibility value of a location. As such, the visibility value may not be indicative of visibility from all angles or pedestrian paths. A location may be highly visible from one sidewalk but may be completely obscured from another. The visibility value may reflect this duality and may be computed to be 0.5 or in effect an average visibility. However, if the pedestrian traffic is different for the two vantage points, then the visibility value may be different. For example, if the first sidewalk is heavily trafficked then the location may be more visible by more potential customers and thus be assigned a higher visibility value. Traffic patterns may change throughout the day as well so that the visibility value may change throughout the day as different vantage points or lines of sight are more or less trafficked. A location that is visible in the morning may be less visible in the evening due to pedestrian flow changes and even less visible at night due to low lighting (for example if the location is not well lit or in the shadows).

In an embodiment, the shared vehicle 124 may play an active role in determining a visibility value by capturing information about nearby elements or objects that are likely to affect its visibility at a particular location. The shared vehicle 124 may use onboard sensors like cameras, proximity sensors, LIDAR, etc. As an example, when a trip is finished, a shared vehicle 124 may be left in a parking location. The shared vehicle 124 may identify its location and acquire proximity data about its nearby surroundings. The shared vehicle 124 may, for example, capture image or lighting data. The data is transmitted to the mapping system 121 for use in calculating a visibility value for the identified location. In an embodiment, the characteristics of a shared vehicle 124 may be taken into account when calculating the visibility value. For example, the size, volume, height, brightness, color, lighting, etc. of a shared vehicle 124 may provide more or less visibility.

In another example, a shared vehicle 124 may be able to identify its orientation and provide this information to the mapping system 121. Different orientations of the shared vehicle 124 may limit its visibility. For example, certain shared vehicles 124 possess different profiles depending on which way they are turned. A shared bicycle may be much easier to spot from a side profile than head on. Similarly, a shared scooter or bicycle that is lying on its side may be much harder to see than if set upright. Shared vehicles 124 may include sensors that allow the shared vehicle 124 to understand its orientation. Shared vehicles 124 may also be equipped with sensors that capture images or other data about the surrounding areas and sight lines.

At Act A140, the visibility value for the location is stored in a visibility index. The visibility index may be stored in the geographic database 123. The visibility index may be updated as new information is acquired about locations. In an embodiment, the visibility value calculations may be stored as an equation that takes into account a base value and various attributes such as a time, a season, a day of the week, weather etc. For example, a visibility value for a particular location may be calculated as 0.50. This value, however, may vary depending on the time of day, for example dropping to 0.25 at night or may vary depending on the day of the week, for example increasing to 0.60 on the weekend because the location includes more pedestrian traffic during Saturday or Sunday. Visibility values may be normalized across multiple locations so that locations may be compared with one another. The calculation may be adjusted based on ground truth data, for example, collected from actual use (finding and renting) of shared vehicles 124 or by annotated data acquired by operators in the field. A location that is more visible than another location should have a value that reflects this difference.

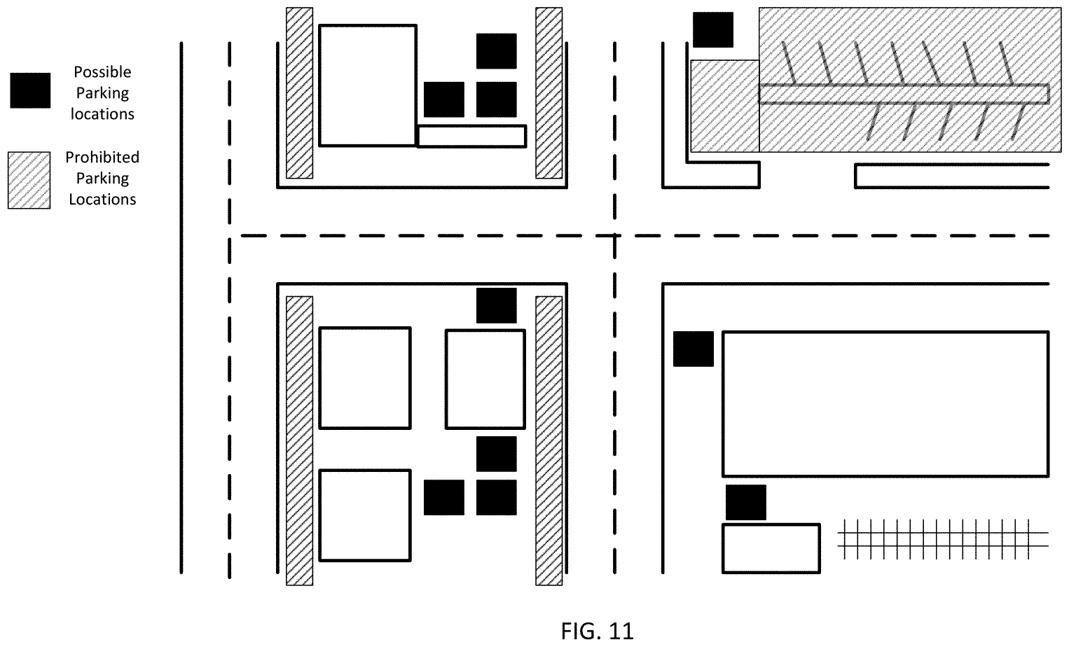

FIG. 11 depicts a visibility index map with a plurality of computed visibility values for an area. As depicted, each of the ten possible parking locations described above have been assigned a visibility value ranging from 0.4 to 1.0. The visibility index map may be used by users or operators to identify promising spots to park vehicles which may be incentivized. The visibility map may be displayed using value or, for example, as a heat map that visually indicates where low visible and high visible parking locations exist.

In an embodiment, the visibility values may be calculated in advance of an actual shared vehicle 124 being parked in each location. The mapping system 121 and geographic database 123 may store data such as three-dimensional maps that allows the mapping system 121 to calculate the visibility values without having an actual shared vehicle 124 visit or be parked in the location. A simple calculation even without three-dimensional maps may be made based on a distance to the street or sidewalk for a potential location. The visibility values may then be updated as new data is made available. In an example, the mapping system 121 may calculate a visibility value for a first location at a first time. At a subsequent time, a user ends a trip and desires to park or store a shared vehicle 124 at the first location. The mapping system 121 may acquire new data about the first location at this subsequent time and make an update to the visibility value.

At act A150, the visibility value is applied to the actual parking or movement of a shared vehicle 124. The visibility values or visibility map may be provided to applications or users. In an embodiment, mobility operators may promote shared vehicles 124 with the lowest visibility value, e.g., shared vehicles 124 that are located in low visibility areas. For example, Mobility operators may incentivize consumers to find and use such vehicles in an area with the lowest visibility value in the area (for example by lowering their price or cost of use) so that there is an increase in the likelihood that a shared vehicle 124 will be used and then parked in a different location in order to be more visible again after use. A shared vehicle 124 parked in a dark alley may cost less to use than a shared vehicle 124 that is parked on a highly sidewalk or dock. Mobility operators' employees may also seek out and find those shared vehicles 124 with the lowest visibility value. The operators may then move the respective shared vehicles 124 to higher visibility locations. Operators may also forbid parking (or charge more) in areas where the visibility value is below a threshold (or likely to go below a threshold within a certain time frame) and hence maintain a dynamic map of areas below visibility threshold. Low visibility areas may also have additional requirements if a user wishes to leave a shared vehicle 124. A user may be required to take a picture or describe the location so that a next user may be able to find the parked shared vehicle 124 easier.

Shared vehicles 124 may also be able to respond or react to being placed in a low visibility location. A shared vehicle 124 that identifies that it is in a low visibility location may move to a different location. The shared vehicle 124 may also activate lights or noise making devices in order to provide additional visibility. In an example, a shared vehicle may project a light towards a reflective surface or a potential user to be more noticeable.

The mapping system 121 may take action to increase the visibility or improve the location of a shared vehicle. An operator may remotely influence the visibility of a shared vehicle 124 by removing hidden elements, when possible, for example other shared vehicles 124 or objects or increasing an intensity of the lights available on the vehicles to make them more visible at specific times of the day. An operator that is able to remotely control a shared vehicle 124 may also remotely move the shared vehicle 124 to a different position. In an embodiment, the mapping system 121 may identify and contact an owner of an obstacle (for example a truck, dumpster, vehicle etc.) and request that the owner move the obstacle. The mapping system 121 may also distinguish between temporary obstacles and more permanent obstacles. For example, if a truck is parked in the way that obscures the location of a shared vehicle 124, the mapping system 121 may forgo contact with the truck owner or performing an operation to move the shared vehicle 124 as the obstacle is temporary (and/or contact the owner or responsible party for the obstacle to determine the length of time that the obstacle is expected to be present). If a truck is parked at a location long term or if, for example, construction work has started that will extend for days, weeks, months, the mapping system 121 may take action to improve the visibility of the location or the shared vehicle 124.

In an embodiment, a user desires to take a trip using a share vehicle. The user opens up a shared mobility application on a device 122 and selects a mode of transportation. The shared mobility application provides several options for the user taking into account visibility values of each vehicle to set the cost of using the vehicle. A vehicle in a dock, for example, may include a surcharge to use as opposed to a dockless vehicle that is located a distance away from the street and that is less visible. The user selects a shared vehicle 124 and attempts to find the shared vehicle 124 using a position (and/or an image) provided by the shared mobility application. When found, the shared mobility application may request feedback from the user on how hard it was to find the shared vehicle 124.

In an embodiment, a user desires to take a trip using a shared vehicle 124. The user does not use an application, but rather finds a shared vehicle 124 by visibly locating the shared vehicle 124 at a particular location. The user uses an application or code to unlock and use the shared vehicle 124. After use, the shared mobility application may request feedback from the user on how hard it was to find the shared vehicle 124. In an embodiment, an operator identifies various shared vehicles 124 that are in low visibility locations and have not been used in a certain amount of time (indicating that they are hard to find). The operator sends out personal to move the respective shared vehicles 124 to higher visibility locations. In an embodiment, a user finishes a trip on a shared vehicle 124 and is prompted to store the shared vehicle 124 in a high visible location. The shared mobility application that is run on a device 122 carried by the user accesses a geographic database 123 that stores a visibility index that stores a collection of visibility values for an area around the end location of the trip. The shared mobility application identifies an acceptable location and provides the location and/or instructions to the user. If the user chooses not to park in the highly visible area, the user may be required to perform additional tasks such as taking a picture, writing a note describing the location, making sure the shared vehicle 124 is upright, turning on a light, etc.

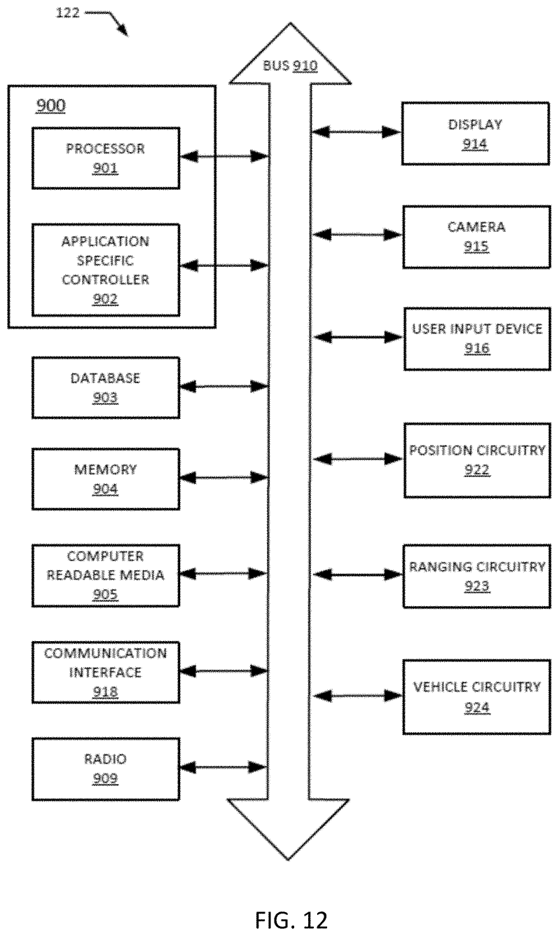

FIG. 12 illustrates an example mobile device 122 for the system of FIG. 1 carried by or otherwise accompanying a pedestrian that is configured to identify a parking location for a share vehicle based on visibility values. The mobile device 122 may include a bus 910 that facilitates communication between a controller 900 that may be implemented by a processor 901 and/or an application specific controller 902, that may be referred to individually or collectively as controller 900, and one or more other components including a database 903, a memory 904, a computer readable medium 905, a communication interface 918, a radio 909, a display 914, a camera 915, a user input device 916, position circuitry 922, and ranging circuitry 923. The contents of the database 903 are described with respect to the geographic database 123. The device-side database 903 may be a user database that receives data in portions from the database 903 of the mobile device 122. The communication interface 918 connected to the internet and/or other networks (e.g., network 127 shown in FIG. 1). Additional, different, or fewer components may be included.

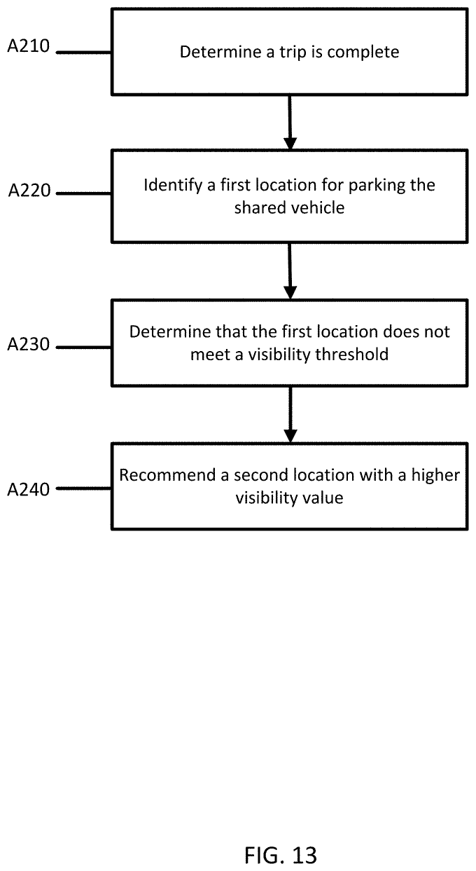

FIG. 13 depicts an example workflow for applying a visibility value using the device 122 of FIG. 12. As presented in the following sections, the acts may be performed using any combination of the components indicated in FIG. 1 or FIG. 12. The following acts may be performed by the server 125, the device 122, the mapping system 121, or a combination thereof. Additional, different, or fewer acts may be provided. The acts are performed in the order shown or other orders. The acts may also be repeated. Certain acts may be skipped.

At act A210, the controller determines that a trip is completed. The use of a shared vehicle 124 starts with a reservation by a user. The user accesses an application run by the controller and stored in the memory, to reserve a shared vehicle 124. The user may access the application using the user input device 916 or other mechanism. The user input device 916 may be one or more buttons, keypad, keyboard, mouse, stylus pen, trackball, rocker switch, touch pad, voice recognition circuit, or other device or component for inputting data to the mobile device 122. The user input device 916 and display 914 be combined as a touch screen, which may be capacitive or resistive. The display 914 may be a liquid crystal display (LCD) panel, light emitting diode (LED) screen, thin film transistor screen, or another type of display. The output interface of the display 914 may also include audio capabilities, or speakers.

The application (e.g., a shared mobility application) identifies the location of the user and the location of potential shared vehicles 124 in the vicinity of the search area. The user selects one of the shared vehicles 124 which is then reserved for that user for a period of time. The user finds the shared vehicle 124 and begins their trip. In another example, a user may not reserve the shared vehicle 124 through the application, but rather come across an unreserved shared vehicle 124, unlocks the shared vehicle 124 using a code or the application and the proceeds on their trip from the starting location where the user unlocked the shared vehicle 124 to a final destination. The controller 900 may include a routing module including an application specific module or processor that calculates routing between an origin and destination. The routing module is an example means for generating a route. The display 914 is an example means for displaying the routing command. The mobile device 122 may generate a routing instruction based on the anonymized data.

The routing instructions may be provided by the display 914. The mobile device 122 may be configured to execute routing algorithms to determine an optimum route to travel along a road network from an origin location to a destination location in a geographic region. Using input(s) including map matching values from the mapping system 121, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile devices 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments. The mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. Non-limiting embodiments of navigation devices may also include relational database service devices, mobile phone devices, car navigation devices, and navigation devices used for air or water travel.

At a subsequent point in time to the start of the trip, the user ends their trip. The shared vehicle 124 may make one or more stops along the way from the start of the trip to the end of the trip. The trip may end at a specific destination or at any point determined by the user. When the user has determined that the user would like to end the trip, the user accesses the application and instructs the application to end the trip. Different mechanisms may also be used to end the trip such as a button or cable or lock on the shared vehicle 124. In either scenario, the application and controller are made aware that the user wishes to end the trip. In an embodiment, the trip may end automatically at a predetermined destination.

At act A220, the controller identifies a first parking location for the shared vehicle 124. The first parking location may be the location where the trip ends or may be a nearby location. For example, the trip may end at a location where there is no permitted parking. The user may be required to move the shared vehicle 124 to a parking location. The controller may use the positioning circuitry 922 to identify the location of the shared vehicle 124.

The positioning circuitry 922 may include suitable sensing devices that measure the traveling distance, speed, direction, and so on, of the mobile device 122. The positioning system may also include a receiver and correlation chip to obtain a GPS signal. Alternatively, or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 922 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 922 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122. The position circuitry 922 may also include gyroscopes, accelerometers, magnetometers, or any other device for tracking or determining movement of a mobile device 122. The gyroscope is operable to detect, recognize, or measure the current orientation, or changes in orientation, of a mobile device 122. Gyroscope orientation change detection may operate as a measure of yaw, pitch, or roll of the mobile device 122.

The ranging circuitry 923 may include a LiDAR system, a RADAR system, a structured light camera system, SONAR, or any device configured to detect the range or distance to objects from the mobile device 122. The ranging circuitry may also include cameras at different angles and may be capable of maintaining a 360° view of its external environment. The device 122 may utilize three-dimensional cameras for displaying highly detailed and realistic images. These image sensors automatically detect objects, classify them, and determine the distances between them and the device 122. For example, the cameras may easily identify other cars, pedestrians, cyclists, traffic signs and signals, road markings, bridges, and guardrails.

In an embodiment, the shared vehicle 124 identifies its location and transmits its location to the device 122. The device 122 may communicate with the shared vehicle 124 using the radio 909 or communications interface 918. The radio 909 may be configured to radio frequency communication (e.g., generate, transit, and receive radio signals) for any of the wireless networks described herein including cellular networks, the family of protocols known as WIFI or IEEE 802.11, the family of protocols known as Bluetooth, or another protocol. The communication interface 918 may include any operable connection. An operable connection may be one in which signals, physical communications, and/or logical communications may be sent and/or received. An operable connection may include a physical interface, an electrical interface, and/or a data interface. The communication interface 918 provides for wireless and/or wired communications in any now known or later developed format.

In an embodiment, the device 122 obtains or capture an image of the parked shared vehicle 124. In an embodiment, the user will obtain or capture the image from a vantage point away from the shared vehicle 124, such as between 3 and 8 meters. In an embodiment, the vantage point is a sufficient distance to capture an image of the shared vehicle 124 as well as surroundings adjacent to the shared vehicle 124. In one example, the vantage point is a position or standpoint from which the shared vehicle 124 is viewed by the user and the user will capture or obtain the image of the shared vehicle 124 amid its surroundings. In one example, the shared vehicle 124 is parked in front of a wall facade or store front along a sidewalk. Therefore, in one embodiment, the image will show the shared vehicle 124 as well as at least a portion of the wall facade or store front. The surroundings around the shared vehicle 124 can include a portion of the street or sidewalk on which the shared vehicle 124 is parked, along with a portion of the backdrop behind the vehicle such as a building front, wall or facade, as well as street sign(s) or an address or name of a business that appears in the surroundings around the parked shared vehicle 124. In certain embodiments, the surroundings include other shared vehicles 124 that may be parked adjacent to the shared vehicle 124 being checked out. The image is accessible by the shared vehicle service.

In one embodiment, the device 122 may determine a location of the shared vehicle 124 by fusing an image-based location with at least one other source of location data indicating a position of the shared vehicle 124 to determine the location of the shared vehicle 124. In one embodiment, the image-based location of the shared vehicle 124 is determined based on at least one of: a geo-tagged location associated with the image; object location data of one or other objects that are photo-identifiable in the image; and image depth data detected by an AR component of the device 122. In one embodiment, the validity of the image for determining the image-based location of the shared vehicle 124 is based on a distance of the camera sensor from the shared vehicle 124, a presence of one or more other photo-identifiable objects that can be used to visually position the shared vehicle 124, or a combination thereof. In one embodiment, the geo-tagged location is determined using a location sensor (e.g., GPS receiver) of the user device 122 at a time of the capture of the image. A position is reported by the camera sensor capturing the picture of the shared vehicle 124, i.e., picture geo-tagging using a user phone or user head mounted device. In one embodiment, a geo-tagged picture is an image which is associated with a geographical location. This may be performed by assigning at least a latitude and longitude to the image, and optionally altitude, compass bearing and other fields may also be included. A camera sensor of a user device 122 is typically provided with a built-in GPS receiver that is configured automatically to perform the geo-tagging.

At act A230, the controller determines that the first parking location is insufficiently visible based on a visibility value for the first parking location. Visibility values may be computed, for example, by the mapping system 121 and stored in a geographic database 123. The visibility value may be computed on demand, for example, when the first parking location is identified. The visibility value may be computed to reflect the difficulty to find the shared vehicle 124 by an average or typical customer. The computation may take into account the pedestrian flow data that describes where and when pedestrians walk and whether or not a potential customer would be able to see or find a shared vehicle 124 at the specified location from the typical path described by the pedestrian flow. The computation may take into account the proximity to well trafficked areas. The computation may take into account moveable or temporary obstacles such as a potential for a parked vehicle or object to block the view of a potential customer of the location. The computation may take into account dynamic factors such as lighting, weather, or seasonal changes. The device 122 may acquire information using one or more sensors in the device 122 or on the shared vehicle 124. The information may include mapping data such as building geometries, roadway data such as traffic flow, image data that describes the lighting or different sight lines, etc. The device 122 may take into account an orientation of the parked shared vehicle such as if the shared vehicle is upright or placed on the ground.

The device 122 may store visibility values in the memory 904. The memory 904 may be a volatile memory or a non-volatile memory. The memory 904 may include one or more of a read-only memory (ROM), random access memory (RAM), a flash memory, an electronic erasable program read only memory (EEPROM), or other type of memory. The memory 904 may be removable from the mobile device 122, such as a secure digital (SD) memory card.

At act A240, the device 122 recommends a second parking location that includes a higher visibility value than the first parking location. Alternatively, or additionally, the device 122 may charge the user a surcharge for using the first parking location or require an additional step such as taking a picture of the low visibility first parking location or describing the first parking location. Such an image or information captured by the device 122 are made available to a potential subsequent user of the shared vehicle 124. The contents of the image may include GPS location data, time stamp data, and other location or orientation data captured by the device 122 and submitted to the shared service provider. This provides the subsequent user with helpful visual information to facilitate their locating or identification of the shared vehicle 124 for their temporary exclusive personal usage.

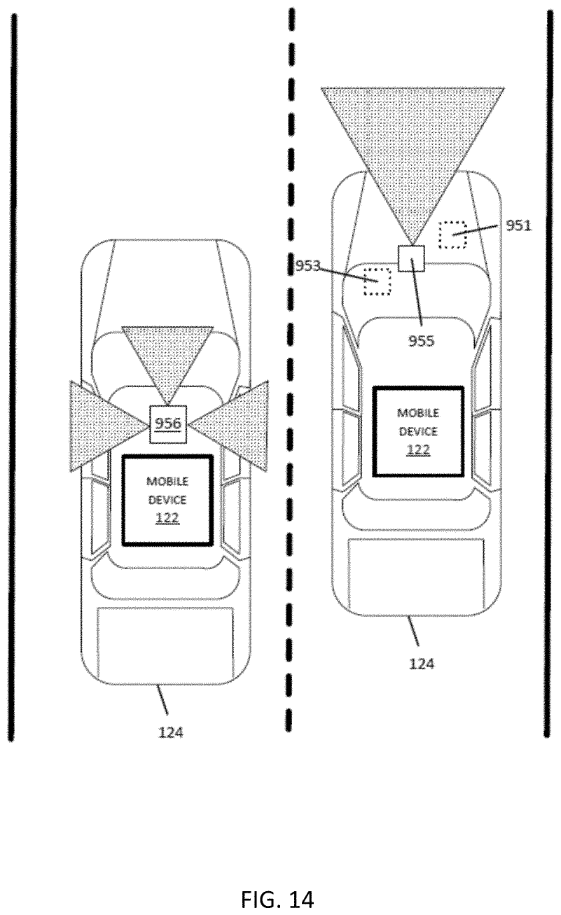

FIG. 14 illustrates exemplary shared vehicles 124 for providing location-based services or application using the systems and methods described herein as well as collecting data for such services or applications described herein. The shared vehicles 124 may include a variety of devices that collect position data as well as other related sensor data for the surroundings of the shared vehicle 124, here depicted as a car, but which use and configuration may be applied to bikesharing, scootersharing, or other shared vehicles 124. The position data may be generated by a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the vehicle 124. The positioning system may also include a receiver and correlation chip to obtain a GPS or GNSS signal. Alternatively, or additionally, the one or more detectors or sensors may include an accelerometer built or embedded into or within the interior of the vehicle 124. The vehicle 124 may include one or more distance data detection device or sensor, such as a LiDAR device. The distance data detection sensor may include a laser range finder that rotates a mirror directing a laser to the surroundings or vicinity of the collection vehicle on a roadway or another collection device on any type of pathway.

A connected vehicle includes a communication device and an environment sensor array for reporting the surroundings of the shared vehicle 124 to the mapping system 121. The connected vehicle may include an integrated communication device coupled with an in-dash navigation system. The connected vehicle may include an ad-hoc communication device such as a mobile device 122 or smartphone in communication with a vehicle system. The communication device connects the vehicle to a network including at least one other vehicle and the mapping system 121. The network may be the Internet or connected to the internet.

The sensor array may include one or more sensors configured to detect surroundings of the shared vehicle 124. The sensor array may include multiple sensors. Example sensors include an optical distance system such as LiDAR 956, an image capture system 955 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera, or another camera.

In some alternatives, additional sensors may be included in the shared vehicle 124. An engine sensor 951 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 953, may include a steering wheel angle sensor, a speedometer sensor, or a tachometer sensor.

A mobile device 122 may be integrated in the shared vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the shared vehicle 124. The assisted driving device may include memory, a processor, and systems to communicate with the mobile device 122. The assisted driving vehicles may respond to the lane marking indicators (lane marking type, lane marking intensity, lane marking color, lane marking offset, lane marking width, or other characteristics) received from geographic database 123 and the mapping system 121 and driving commands or navigation commands.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) received from geographic database 123 and the mapping system 121 and driving commands or navigation commands.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) received from geographic database 123 and the mapping system 121 and driving commands or navigation commands.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) received from geographic database 123 and the mapping system 121 and driving commands or navigation commands.

The term “computer-readable medium” includes a single medium or multiple medium, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in the specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

As used in the application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a GPS receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may be a non-transitory medium such as a ROM, RAM, flash memory, etc. The processor and the memory may be supplemented by, or incorporated in, special purpose logic circuitry.

To provide for interaction with a user, embodiments of the subject matter described in this specification may be implemented on a device having a display, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the subject matter described in this specification may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the subject matter described in this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A method for computing a visibility value for a shared vehicle, the method comprising:
identifying a possible storage location for the shared vehicle;
calculating a plurality of pedestrian paths for areas within line of sight of the possible storage location;
determining line of sight data for the possible storage location and the plurality of pedestrian paths based on three-dimensional mapping data;
computing a visibility value for the possible storage location as a function of the plurality of pedestrian paths and line of sight data; and
storing the visibility value for the possible storage location in a visibility index.

2. The method of claim 1, further comprising:
depicting a plurality of visibility values in the visibility index in a visibility map.

3. The method of claim 1, wherein the visibility value for the possible storage location is further computed based on dynamic factors including at least one of weather, seasonal obstacles, or vehicle parking.

4. The method of claim 1, wherein the visibility value for the possible storage location is computed differently for different times of a day.

5. The method of claim 1, further comprising:
acquiring proximity data from the shared vehicle at the possible storage location,
wherein the visibility value is computed based further on the proximity data.

6. The method of claim 1, wherein the shared vehicle comprises a shared bicycle or shared scooter.

7. The method of claim 1, further comprising:
generating an alert when a respective shared vehicle is stored in a respective storage location that includes a respective visibility value below a predefined threshold.

8. The method of claim 1, wherein storing of shared vehicles is prohibited by a shared vehicle operator in locations that include a visibility value below a predefined threshold.

9. The method of claim 1, wherein the visibility value is computed based further on a pedestrian flow value for the plurality of pedestrian paths.

10. A method for storing a shared vehicle, the method comprising:
determining, by a shared mobility application, that an operation of a shared vehicle by a user is finished;
identifying, by the shared mobility application, a first location for storage or parking of the shared vehicle;
determining, by the shared mobility application, that the first location is insufficiently visible based on a visibility value for the first location; and
recommending, by the shared mobility application, a second location for storage or parking of the shared vehicle, wherein the second location includes a visibility value higher than the visibility value for the first location.

11. The method of claim 10, further comprising:
charging the user an additional fee if the user parks or stores the shared vehicle at the first location.

12. The method of claim 10, further comprising:
alerting one or more operators that the shared vehicle is parked at the first location, wherein the one or more operators are tasked with moving the shared vehicle to a location with a higher visibility value.

13. The method of claim 10, wherein the shared vehicle comprises a shared bicycle or shared scooter.

14. The method of claim 10, wherein the user is prohibited from storing or parking the shared vehicle at the first location.

15. A system for computing a visibility value for a shared vehicle, the system comprising:
a geographic database configured to store mapping data for at least a plurality of possible storage locations for the shared vehicle; and
a processor configured to determine line of sight data for the plurality of possible storage locations from a plurality of observer points based on the mapping data and compute a visibility value for each of the plurality of possible storage locations as a function of the line of sight data, wherein the visibility values are stored in a visibility index that is part of the geographic database.

16. The system of claim 15, wherein each visibility value is further computed based on dynamic factors including at least one of weather, seasonal obstacles, or lighting.

17. The system of claim 15, wherein each visibility value is computed differently for different times of a day.

18. The system of claim 15, wherein the shared vehicle comprises a shared bicycle or shared scooter.

19. The system of claim 15, further comprising:
one or more devices configured to run a shared mobility application that provides recommendations on where to park the shared vehicle based on the visibility values.

20. The system of claim 19, wherein the shared mobility application prohibits a user from parking the shared vehicle in a location that does not meet a visibility value threshold.
